(19) United States
(12) Patent Application Publication
(10) Pub. No.: US 2012/0180057 A1
(43) Pub. Date: Jul. 12, 2012

(54) Activity Recording System for a Concurrent Software Environment

(75) Inventors: Frank E. Levine, Austin, TX (US); Enio M. Pineda, Austin, TX (US); David K. Siegwart, Eastleigh (GB)

(73) Assignee: International Business Machines Corporation, Armonk, NY (US)

(21) Appl. No.: 13/340,486

(22) Filed: Dec. 29, 2011

(30) Foreign Application Priority Data
Jan. 10, 2011 (GB) 11150482.5

(51) Int. Cl. G06F 9/46

(52) U.S. Cl. 718/102

(57) ABSTRACT

An activity recording system for a concurrent software environment executing software threads in a computer system, the activity recording system comprising: a thread state indicator for recording an indication of a synchronization state of a software thread, the indication being associated with an identification of the software thread; a time profiler for polling values of a program counter for a processor of the computer system at regular intervals, the time profiler being adapted to identify and record one or more synchronization states of the software thread based on the polled program counter value and the recorded indication of state.

### BACKGROUND

1. Field

The present invention relates to recording activity for a concurrent software environment. In particular, it relates to recording information relating to the synchronization state of threads in the concurrent software environment.

2. Background of the Invention

Concurrent software environments executing software threads in a computer system employ one or more synchronization mechanisms to ensure controlled access to shared resources and to avoid the simultaneous use of shared resources. For example, software methods executing in a concurrent software environment can be synchronized using a mutual exclusion (mutex) algorithm, a software lock, a synchronization monitor, semaphores or other synchronization mechanisms known in the art.

High scalability of multi-threaded applications running in concurrent software environments, such as Java (Java is a trademark of Oracle Corporation), depend on good tools to find areas of the software code presenting opportunities to improve scalability by alleviating or addressing issues manifesting as contention to access synchronized shared resources. Identification of such areas of software code is aided by facilities for measuring occurrences of synchronization events, such as contention between software threads sharing shared resources.

However, instrumentation of software code in order to measure synchronization events presents difficulties. Contention is very sensitive to tool overhead since the very execution of monitoring and measuring tools effects the synchronization dynamics of software running in a concurrent software environment.

Current tools such as the Java Lock Monitor (JLM) (see perfinsp.sourceforge.net/jlm.html) or the “IBM Monitoring and Diagnostic Tools for Java—Health Centre” (see publib.boulder.ibm.com/infocenter/hctool/v1r0/index.jsp) provide monitoring and reporting of incidences of contention in the Java environment on a synchronized resource basis. However, these tools are unable to provide information on the state of a software thread at the time of contention, such as the particular software method experiencing contention. Thus, using such tools it is not straightforward to determine which software methods in an application are responsible for occurrences of contention.

Further, tools measuring a length of time a software method executing in a software thread is in a particular synchronization state, such as a particular state of contention, are difficult to develop and maintain. By virtue of the nature of the concurrent software environment, the propensity for software threads to be interrupted and resumed as part of the synchronization mechanism requires complex measuring logic to determine appropriate allocation of time periods to particular synchronization states, particular software methods and particular software threads.

It would therefore be advantageous to record activity of threads in a concurrent software environment to assist with an analysis of synchronization behavior to improve scalability of concurrent software.

### SUMMARY

The present invention accordingly provides, in a first aspect, an activity recording system for a concurrent software environment executing software threads in a computer system, the activity recording system comprising: a thread state indicator for recording an indication of a synchronization state of a software thread, the indication being associated with an identification of the software thread; a time profiler for polling values of a program counter for a processor of the computer system at regular intervals, the time profiler being adapted to identify and record one or more synchronization states of the software thread based on the polled program counter value and the recorded indication of state.

Preferably, the record of the synchronization state(s) of the software thread is derived from the polled program counter value and the recorded indication of state.

Thus, the activity recording system records synchronization state information for threads executing in a concurrent software environment at regular time intervals by polling of the time profiler. Such polling can be a fine grained or atomic process presenting extremely low processing overhead for the computer system and, thus, has a substantially negligible impact on the synchronization dynamics of the concurrent software environment. Also, with respect to the concurrent software environment, the processing of the time profiler is passive insofar as the polling of program counter values and obtaining synchronization state indication do not require the active involvement of the concurrent software environment. Further, the regularly timed synchronization state information for the multiple software threads can inform a process of analyzing the synchronization behavior of the software threads to improve efficiency, operability and scalability of concurrent software environment.

Preferably, the record of the synchronization state(s) of the software thread is derived from the polled program counter value and the recorded indication of state.

Preferably, the activity recording system further comprises a calculation component for calculating a proportion of the regular intervals of the time profiler for which the thread was in an indicated state.

Preferably, the activity recording system further comprises a resolver for determining a symbolic name associated with an instruction at an address indicated by a value of the program counter for the processor.

Preferably, the thread state indicator is operable to record an indication of a ‘held’ state of the software thread, whereby the software thread actively executes in a processor of the computer system, and acquires an exclusionary construct for achieving synchronization in the concurrent software environment; an indication of a ‘spin’ state of the software thread, whereby the software thread actively executes in a processor of the computer system, seeks to acquire the exclusionary construct, and is unable to acquire the exclusionary construct; and an indication of an unsynchronized state of the software thread.

Preferably, the indication of a synchronization state of the software thread further includes an identifier of a shared resource sought for access by the software thread.

Preferably, the resolver is further operable to determine a symbolic name associated with the identifier of a shared resource.

Preferably, the symbolic name is a name of a software routine associated with the instruction, including one of a name of a software method and a name of a software function.

Preferably, the time profiler is further adapted to determine that the software routine is included in a service library of routines of the software environment, and in response to the determination, identify a calling routine for the software routine.

Preferably, the time profiler identifies the calling routine using one or more of the resolver and a software call stack.

Preferably, the synchronization state of the software thread is determined by one or more of the software thread itself and the concurrent software environment.

Preferably, the exclusionary construct is one of a lock and a monitor.

Preferably, the shared resource is a software object.

The present invention accordingly provides, in a second aspect, a method for recording activity for a concurrent software environment executing software threads in a computer system, the method comprising the steps of: a thread state indicator recording an indication of a synchronization state of a software thread, the indication being associated with an identification of the software thread; a time profiler polling values of a program counter for a processor of the computer system at regular intervals; the time profiler identifying and recording one or more synchronization states of the software thread based on the polled program counter value and the recorded indication of state.

The present invention accordingly provides, in a third aspect, an apparatus comprising: a central processing unit; a memory subsystem; an input/output subsystem; and a bus subsystem interconnecting the central processing unit, the memory subsystem, the input/output subsystem; and the apparatus as described above.

The present invention accordingly provides, in a fourth aspect, a computer program element comprising computer program code to, when loaded into a computer system and executed thereon, cause the computer to perform the steps of a method as described above.

### BRIEF DESCRIPTION OF THE SEVERAL VIEWS OF THE DRAWINGS

A preferred embodiment of the present invention is described below in more detail, by way of example only, with reference to the accompanying drawings, in which:

FIG. 1 is a block diagram of a computer system suitable for the operation of embodiments of the present invention;

FIG. 2 illustrates an arrangement of an activity recording system implemented in a computer system in accordance with a preferred embodiment of the present invention;

FIG. 3 is a flowchart of a method for recording activity for the concurrent software environment executing software threads in the computer system in accordance with a preferred embodiment of the present invention;

FIG. 4 illustrates an enhanced arrangement of an activity recording system implemented in a computer system in accordance with a preferred embodiment of the present invention; and

FIG. 5 is a flowchart of an enhanced method for recording activity for the concurrent software environment executing software threads in the computer system in accordance with a preferred embodiment of the present invention.

### DETAILED DESCRIPTION

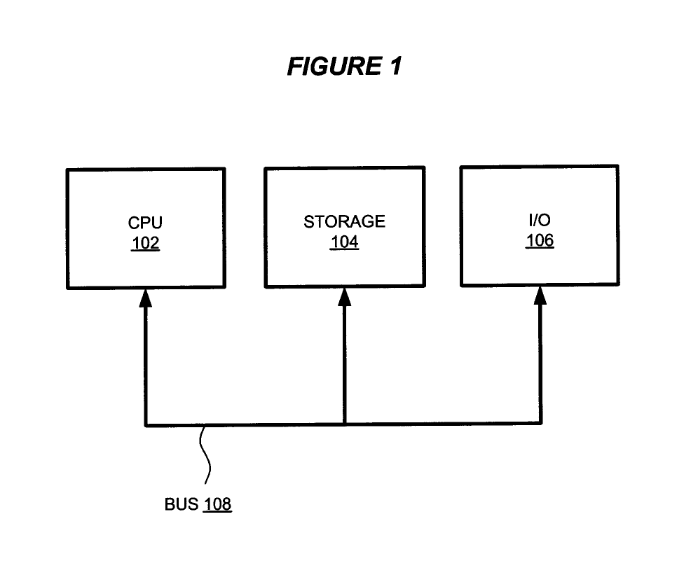

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

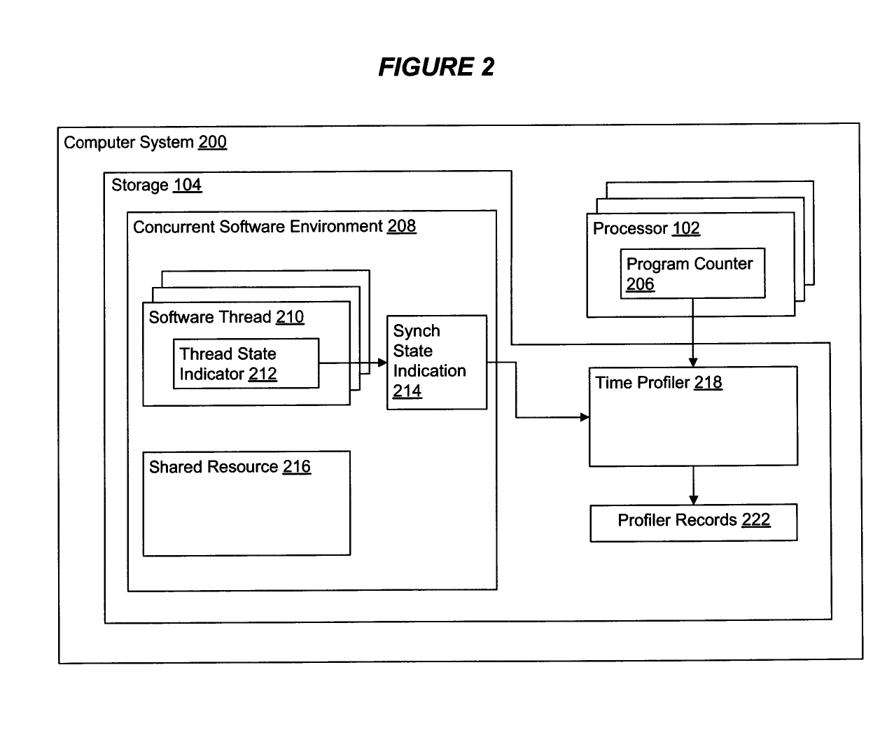

FIG. 2 illustrates an arrangement of an activity recording system implemented in a computer system 200 in accordance with a preferred embodiment of the present invention. The computer system 200 includes one or more processors 102 for the execution of instructions. Each processor 102 in the computer system 200 includes a program counter 206 as a register or other suitable store for storing a value indicating a current position in a sequence of instructions executed by the processor 102. Program counters are also known as instruction pointers, instruction address registers or instruction sequencers. Program counter 206 can hold an address for an instruction currently being executed or, alternatively, an address for a next instruction to be executed, depending on a particular arrangement of processor 102.

Preferably, processors 102 are multiple independent processors in a multiprocessor computer system. Alternatively, processors 102 can be constituted as separate computing systems organised in a network of interoperating computer systems, such as an array of computer systems. Each system in such an array can independently contain the essential features of a computer system outlined above with respect to FIG. 1. For example, processors 102 can be constituted within a rack computer arrangement, a blade server or other suitable array of computer systems. In a further alternative, processors 102 can be constituted as separate processing elements of a single processor, such as separate processing cores of a processor unit. Combinations of such processor arrangements conceived here are also suitable in embodiments of the one or more processors 102.

The computer system 200 further includes storage 104 such as a volatile memory store. Storage 104 stores a time profiler 218. Time profiler 218 is a component for recording values of the program counter 206 for processor 102 in the computer system 200. The values of the program counter 206 are recorded as profiler records 222 in storage 104, an alternative memory or other store associated with the computer system 200.

In operation, the time profiler 218 interrupts the execution of processor 102 periodically (known as a profiler ‘tick’) to record a value of the program counter 206 before resuming execution of interrupted instructions. A value of the program counter 206 corresponds to an address in the storage 104 of an instruction in an instruction sequence for a software thread 210 executing on the processor 102 at the time of the profiler interruption (the tick). The interruptions take place at regular intervals such that a value of the program counter 206 is polled at regular intervals by the time profiler 218. The time profiler 218 can be further operable to record values of program counters for multiple processors in computer system 200, including creating a record of an identifier of a processor corresponding to each value of a program counter 206.

As will be apparent to those skilled in the art, the time profiler 218 can be implemented entirely in software stored in the store 104. For example, the time profiler 218 can be based on an application tool, such as the “TProf” Time Profiler tool developed by IBM and detailed at perfinsp.sourceforge.net/tprof.html (IBM is a registered trademark of International Business Machines Corporation).

Alternatively, the time profiler 218 can be implemented outside the store 104 embodied entirely in hardware, or a combination of both software and hardware. For example, the time profiler 218 can be a software routine executing on computer system 200, such as an operating system or kernel function having close cooperation with the one or more processors 102 of the computer system 200. Alternatively, the time profiler 218 can employ processor instructions specifically directed to storing a value of the program counter 206. In a further alternative, the time profiler 218 may be a function of a Just In Time (JIT) compiler for the concurrent software environment 208, known as a “sampling thread”.

Storage 104 further stores a concurrent software environment 208. Concurrent software environment 208 is an environment in which software is designed as a collection of one or more computational processes suitable for execution simultaneously in parallel. Notably, the suitability for such parallel simultaneous execution does not necessarily require that concurrent software is actually executed in parallel. A concurrent software environment can imitate parallel execution using a single processor 102, or can implement true parallel execution using multiple processors 102, such as in any of the arrangements of processors 102 described above. Concurrent programs can be executed sequentially on a single processor by interleaving the execution steps of each computational process, or executed in parallel by assigning each computational process to one of a set of processors 102 that may be close or distributed across a network. An example of such a concurrent software environment is a Java Runtime Environment.

A plurality of software threads 210 in the computer system 200 execute concurrently in the concurrent software environment 208 as concurrent computational processes. For example, software threads 210 are threads of execution in a Java program including software methods executing for instantiated Java objects.

Software threads 210 are each operable to access a shared resource 216. Shared resource 216 can be any resource suitable for access by threads in the concurrent software environment 208 such as a hardware or software resource, shared memory area or other storage, a device, processor or any other resource. For example, the shared resource 216 can be a Java object, such as a Java object including synchronized software methods in the Java environment.

The concurrent software environment 208 employs one or more synchronization mechanisms to ensure controlled access to the shared resource 216 and to avoid the simultaneous use of the shared resources 216 by multiple software threads 210.

For example, the concurrent software environment 208 can synchronize software threads 210 using a mutual exclusion (mutex) algorithm, a software lock, a synchronization monitor, semaphores or other synchronization mechanisms known in the art. Such mechanisms can employ an exclusionary construct to avoid the simultaneous use of shared resource 216. Exclusionary constructs used in such synchronization mechanisms can include locks, monitors and semaphores.

For example, the software threads 210 accessing a software object having a synchronized software method as shared resource 216 can be synchronized by the use of a software monitor to restrict access to the software object to a single thread at any one point in time. Different states of operation can be used to describe a thread operating in environments synchronized by exclusionary constructs.

A software thread 210 executing in computer system 200 which seeks to obtain access to shared resource 216 can be said to seek to “acquire” an exclusionary construct associated with shared resource 216. Similarly, a thread 210 currently enjoying synchronized access to shared resource 216 can be said to be “holding” an exclusionary construct associated with shared resource 216, also known as a “held” state of the software thread 210.

Synchronization mechanisms to achieve the sharing of shared resource 216 involve threads entering other states of operation. A synchronization mechanism can require a thread 210 seeking to acquire an exclusionary construct to enter a “spin” state before it can hold the exclusionary construct. A thread in the “spin” state is actively executing on a processor 102 but is unable to access the shared resource 216 associated with the exclusionary construct. Normally, a thread in a “spin” state is not able to perform useful work as it seeks to acquire the exclusionary construct, and thus such threads normally do not execute other software routines or methods while in the “spin” state.

Synchronization mechanisms can lead to a thread 210 failing to acquire an exclusionary construct for the shared resource 216 leaving the thread in a “blocked” state, unable to access the shared resource 216. Threads in a “blocked” state are unable to execute and cease to be subject to processing by any processor 102 in the computer system 200 while in the “blocked” state. Such blocking can be temporary where the exclusionary construct subsequently becomes available for the thread 210 to acquire.

A thread 210 holding an exclusionary construct can enter a “wait” state while the thread 210 waits for processing to be undertaken by another thread. Such “wait” states are normally exited by receipt of a notification or, in the case of “timed wait” states, by expiry of a predefined time period. Threads 210 in the “wait” and “timed wait” states are unable to execute and cease to be subject to processing by any processor 102 in the computer system 200 until the notification is received by the thread 210 or the time period expires. Threads which enter a “wait” state normally release an exclusionary construct and re-acquire it when they exit the “wait” state.

Further, threads 210 can be in a “runnable” state, being a state where a thread 210 is able and ready to execute on a processor 102 of the computer system 200 but where no processor 102 is currently assigned to the thread 210 for execution.

Each of the software threads 210 includes a thread state indicator 212 for recording an indication of a current synchronization state 214 for the thread 210. The indication 214 is associated with a particular thread 210 and can indicate any or all of the states of: “held”; “spin”; “blocked”; “wait” (either “wait” or “timed wait”); “runnable”; and an indication of an unsynchronized state of the software thread 210. In one embodiment, the indication 214 is set by the software thread itself. In an alternative embodiment, the indication 214 is set by the concurrent software environment 208, such as by a virtual machine in a Java Runtime Environment.

The arrangement of FIG. 2 will now be described in use to demonstrate the advantages of embodiments of the present invention. In use, the indication 214 is set at, shortly before, or shortly after, a change to the synchronization state of software thread 210. For example, software thread 210 that is about to acquire a synchronization construct for access to the shared resource 216 updates the indication 214 to reflect a ‘held’ state. Similarly, software thread 210 that is about to enter a ‘spin’ state updates the indication 214 to reflect a ‘spin’ state.

In use, the time profiler 218 polls and records regular values of program counter 206 for each of the one or more processor 102 to the profiler records 222. The time profiler 218 is adapted to record a synchronization state to the profiler records 222 for a software thread 210 executing on a polled processor 102. The synchronization state is derived from an identification of which thread 210 is executing on the polled processor 102 and the indication of synchronization state 214 stored by the thread 210. State information for threads in states which involve executing on one of the one or more processors 102 can be determined and recorded in this way. This includes the ‘spin’, the ‘held’ state, and the unsynchronized execution state.

Thus, in use, the arrangement of FIG. 2 is operable to record synchronization “held” and “spin” state information for threads 210 executing in the concurrent software environment 208 at regular time intervals by polling of the time profiler 218. Such polling can be a fine grained or atomic process presenting extremely low processing overhead for the computer system 200 and, thus, has a substantially negligible impact on the synchronization dynamics of the concurrent software environment 208. Also, with respect to the concurrent software environment 208, the processing of the time profiler 218 is passive insofar as the polling of program counter 206 values and obtaining synchronization state indication 214 do not require the active involvement of the concurrent software environment 208. Further, the regularly timed synchronization “held” and “spin” state information for the multiple software threads 210 can inform a process of analyzing the synchronization behavior of the software threads 210 to improve efficiency, operability and scalability of concurrent software environment 208.

In one embodiment, each value of the program counter 206 is resolved to an identification of an executing software method for a thread executing on processor 102. For example, the time profiler 218 can use a resolver to determine, for each address value of the program counter 206 recorded by the time profiler 218, a symbolic name identifying software code for a software thread 210 including an instruction stored at the address. Thus, symbol names including function, procedure, subroutine or method names in a thread 210 are retrieved by the resolver for each address recorded by the time profiler 218. The resolver can be a function of the time profiler 218 or can be a supplementary function or tool stored in storage 204.

The arrangement of FIG. 2 can further include a calculation component for calculating a proportion of the regular intervals profiled by the time profiler 218 for which a thread 210 was in a particular synchronization state. For example, a percentage of total time that a thread 210 was in a ‘held’ state can be calculated. Such calculation component can be comprised as part of the time profiler 218. Alternatively, such calculation component can be a separate or additional software or hardware component interacting with the profiler records 222 generated by the profiler component 218.

In a preferred embodiment, the thread state indicator 212 additionally records an identification of the shared resource 216 sought for access by the software thread 210. For example, the thread state indicator 212 can record the identification along with the synchronization state information 214. Such identification can include, for example, a class name of an object or an identifier of a synchronized software method, routine, device, data item or other shared resource. Further, in a preferred embodiment, the resolver is operable to determine a symbolic name associated with an identifier of the shared resource 216 recorded by the thread state indicator 212. For example, a name of a software routine such as a software method or function is recorded with the synchronization state indication 214. Where the shared resource 216 includes software objects including objects having synchronized routines, such as a synchronized software method, the shared resource 216 might correspond to a routine in a service library called by a calling software routine, such as a class library, standard library, service routine or primitive method or function. In such situations it can be unhelpful to record an indication of the routine itself (since such routines can be called frequently by many methods) and instead, an identifier of a ‘calling’ routine can be determined and recorded additionally or instead. Such ‘calling’ routine can be identified from a call stack and/or resolver.

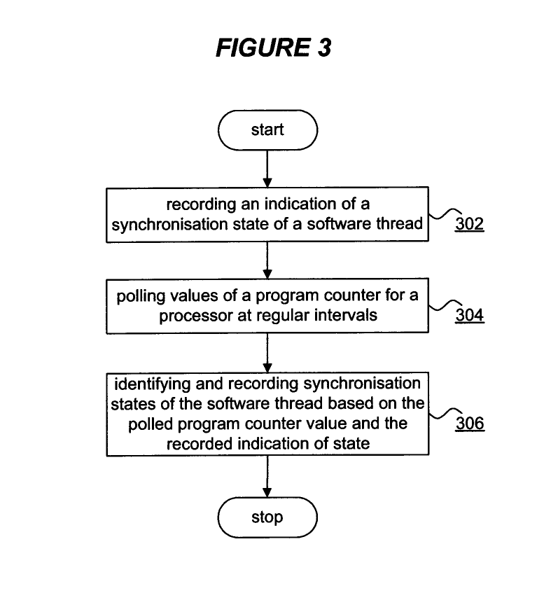

FIG. 3 is a flowchart of a method for recording activity for the concurrent software environment 208 executing software threads 210 in the computer system 200 in accordance with a preferred embodiment of the present invention. At step 302, the thread state indicator 212 records an indication of a synchronization state 214 for a software thread 210, the indication being associated with an identification of the software thread 210. At step 304, the time profiler 218 polls values of the program counter 206 for the one or more processors 102 at regular intervals. At step 306, the time profiler 218 identifies and records one or more synchronization states of the software thread 210 derived from the polled program counter value 206 and the recorded indication of state 214.

The embodiments described above are suitable for recording synchronization “held” and “spin” state information for threads 210 actively executing on one or more of the processors 102. The above embodiments rely on polling the program counter 206 and thread synchronization state indication 214 and so only provide useful information for threads actively executing on a processor 102. Threads not actively executing on a processor 102, such as threads in a “blocked”, “wait” (either “wait” or “timed wait”) or “runnable” states, will not be identified by the polling of the time profiler 218 described above. Accordingly, an additional approach is required to record activity for threads in these states.

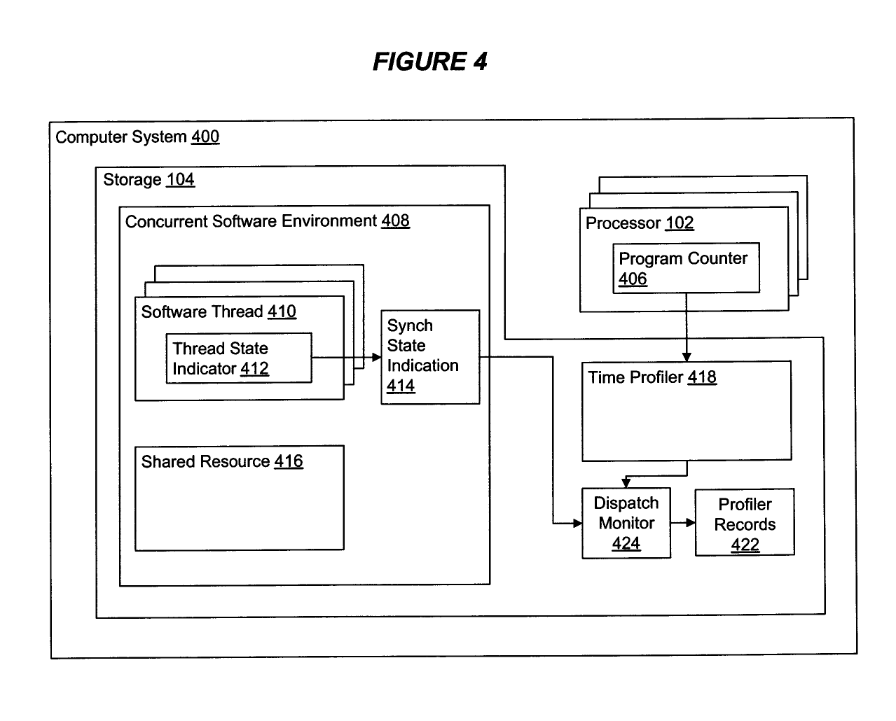

FIG. 4 illustrates an enhanced arrangement of an activity recording system implemented in a computer system 400 in accordance with a preferred embodiment of the present invention. Many of the features of FIG. 4 are identical to those described above with respect to FIG. 2 and these will not be repeated here. The arrangement of FIG. 4 is enhanced with respect to FIG. 2 in that the arrangement of FIG. 4 is suitable for recording synchronization state information for software threads 410 in the concurrent software environment 408 where the threads are not actively executing in a processor 102 of the computer system 400. The arrangement depicted in FIG. 4 can supplement the arrangement of FIG. 2 such that, in certain embodiments, the features described with respect to FIG. 2 can be implemented in addition to the features described below with respect to FIG. 4.

The thread state indicator 412 of FIG. 4 is operable to record indications of a synchronization state of software threads 410 in which the software thread ceases to execute in a processor 102 of the computer system 400. Thus, in the arrangement of FIG. 4, the thread state indicator 412 records indications of “blocked”, “wait” (either “wait” or “timed wait”) and “runnable” states to the synchronization state indication 414. Otherwise the thread state indicator 412 of FIG. 4 is substantially identical to that described above with respect to FIG. 2.

The time profiler 418 of FIG. 4 is operable to identify one or more processors 102 being idle. A processor 102 is considered to be idle if none of the software threads 410 are dispatched to execute on the processor 102. The time profiler 418 records such idleness, such as by storing an indication that a processor 102 is idle at a particular point in time. In an alternative embodiment, the time profiler 418 is further operable to identify a time period over which the processor 102 is continuously idle as an idle period for the processor 102.

The storage 104 of FIG. 4 further stores a dispatch monitor 424. Dispatch monitor 424 is operable to identify when a software thread 410 is dispatched for execution on a processor 102. The dispatch monitor 424 can be implemented as a software routine coexisting with the concurrent software environment and the time profiler 418. Alternatively, the dispatch monitor 424 can be implemented in an operating system or kernel of the computer system 400. Conceivably the dispatch monitor 424 can be implemented entirely or partly in hardware.

In use, the dispatch monitor 424 identifies the dispatch of a software thread 410 to a processor 102. In response to such identification, the dispatch monitor 424 determines if the processor 102 to which the thread is dispatched was idle immediately before the dispatch by reference to the time profiler 418. If the processor 102 was idle, the dispatch monitor 424 obtains a synchronization state of the dispatched thread 410 to determine if the dispatched thread 410 is in a synchronization state that may account for the idleness of the processor 102. For example, if the synchronization state indication 414 for the dispatched thread 410 indicates that the thread 410 was blocked (a “blocked” state) up to the point of dispatch, the blocking may account for the idleness of the processor 102. Such conclusions can be drawn for “blocked”, “wait” (“wait” and “timed wait”) and “runnable” states of software threads 410. In an alternative embodiment, when a continuous idle period is recorded for a processor 102, the synchronization state may account for the idle period and may be attributed to idle period.

Where the dispatch monitor identifies a synchronization state of a dispatched thread 410 that accounts for the idlebess of a process 102, the dispatch monitor generates a record of the synchronization state of the thread, such as in profiler records 422, and attributes the idleness to the dispatched thread and the indicated synchronization state of the dispatched thread 410. In this way idleness of processors 102 that may be caused by particular synchronization states of threads 410 are attributed to those states and threads.

Thus the arrangement of FIG. 4 is operable to record synchronization “blocked”, “wait” and “runnable” state information for threads 410 executing in the concurrent software environment 408 and attribute such states to idleness of processors 102 identified by the time profiler 418. Checking and polling by the time profiler 418 and the dispatch monitor 424 can be fine grained or atomic processes presenting extremely low processing overhead for the computer system 400 and, thus, have a substantially negligible impact on the synchronization dynamics of the concurrent software environment 408. Also, with respect to the concurrent software environment 408, the processing of the time profiler 418 and dispatch monitor 424 is passive insofar as the checking for idleness of processors 102 and polling of synchronization state information 414 do not require the active involvement of the concurrent software environment 408. Further, the records of “blocked”, “wait” and “runnable” state information for the multiple software threads 410 can inform a process of analyzing the synchronization behavior of the software threads 410 to improve efficiency, operability and scalability of concurrent software environment 408.

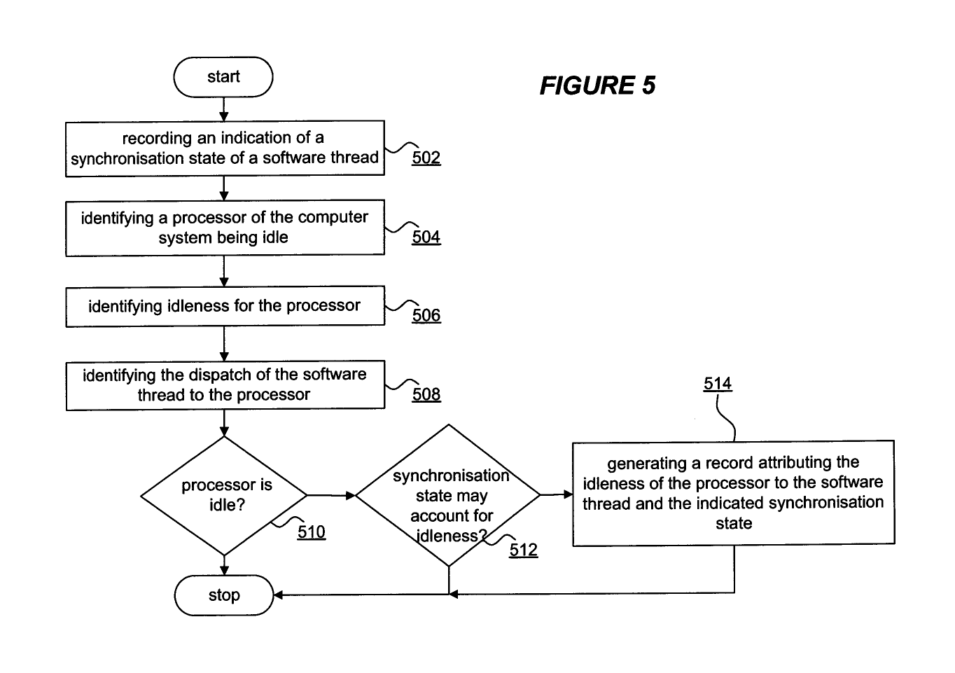

FIG. 5 is a flowchart of a method for recording activity for the concurrent software environment 408 executing software threads 410 in the computer system 400 in accordance with a preferred embodiment of the present invention. At step 502, the thread state indicator 412 records an indication of a synchronization state 414 of a software thread 410 in which the software thread 410 ceases to execute in a processor 102 of the computer system 400. The indication 414 is associated with an identification of the software thread 410. At step 504, the time profiler 418 identifies a processor 102 of the computer system 400 being idle and records an indication that the processor is idle. At step 506, the time profiler 418 identifies idleness of the processor 102. In a preferred embodiment, the idleness is identified as an idle period during which the processor is continuously idle. At step 508, the dispatch monitor 424 identifies the dispatch of the software thread 410 to the processor 102. At step 510 the method determines if the processor is idle. At step 512, the method determines if the synchronization state of the dispatched method 410 may account for the idleness (e.g. a “blocked”, “wait” or “runnable” state). At step 514, the dispatch monitor 424 generates a record in the profiler records 422 attributing the idleness of the processor 102 to the software thread 410 and the indicated synchronization state for the software thread 410. Preferably, the time profiler 418 is further operable to reset the indication that a processor 102 is idle in response to the dispatch monitor 424 identifying the dispatch of a thread to the processor 102.

The arrangement of FIG. 4 can further include a calculation component for calculating a proportion of time profiled by the time profiler 418 and dispatch monitor 424 for which a thread 410 was in a particular synchronization state. For example, a calculation of a percentage of total time that a processor 102 is idle being attributed to a thread 410 being in a “blocked” state. Such calculation component can be comprised as part of the time profiler 418 or as part of the dispatch monitor 424. Alternatively, such calculation component can be a separate or additional software or hardware component.

In a preferred embodiment, the time profiler 418 of FIG. 4 can further include the regular program counter polling features of the time profiler of FIG. 2. The program counter polling conducted by such a time profiler 418 can be employed to measure an idle period for an idle processor 102 by counting a number of regular intervals during which the processor 102 is idle. Further, the idle period can be recorded by the time profiler 418 as a count of regular intervals along with the indication that the processor 102 is idle.

In a preferred embodiment, the thread state indicator 412 additionally records an identification of the shared resource 416 sought for access by the software thread 410, as described above with respect to FIG. 2. The arrangement of FIG. 4 can further include the resolver described above with respect to FIG. 2 for performing resolution of symbolic names.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

What is claimed is:

1. An activity recording system for a concurrent software environment executing software threads in a computer system, the activity recording system comprising:
a thread state indicator for recording an indication of a synchronization state of a software thread executing in the computer system, the indication being associated with an identification of the software thread; and
a time profiler for polling values of a program counter for a processor of the computer system at regular intervals, the time profiler being adapted to identify and record one or more synchronization states of the software thread based on the polled program counter value and the recorded indication of state.

2. The activity recording system of claim 1 further comprising:
a calculation component for calculating a proportion of the regular intervals of the time profiler for which the thread was in an indicated state.

3. The activity recording system of claim 2 further comprising:
a resolver for determining a symbolic name associated with an instruction at an address indicated by a value of the program counter for the processor.

4. The activity recording system of claim 3 wherein the thread state indicator is operable to record:
an indication of a ‘held’ state of the software thread, whereby the software thread actively executes in a processor of the computer system, and acquires an exclusionary construct for achieving synchronization in the concurrent software environment;
an indication of a ‘spin’ state of the software thread, whereby the software thread actively executes in a processor of the computer system, seeks to acquire the exclusionary construct, and is unable to acquire the exclusionary construct; and
an indication of an unsynchronized state of the software thread.

5. The activity recording system of claim 4 wherein the indication of a synchronization state of the software thread further includes an identifier of a shared resource sought for access by the software thread.

6. The activity recording system of claim 5 wherein the resolver is further operable to determine a symbolic name associated with the identifier of a shared resource.

7. The activity recording system of claim 4 wherein the symbolic name is a name of a software routine associated with the instruction, including one of a name of a software method and a name of a software function.

8. The activity recording system of claim 7 wherein the time profiler is further adapted to determine that the software routine is included in a service library of routines of the software environment, and in response to the determination, identify a calling routine for the software routine.

9. The activity recording system of claim 8 wherein the time profiler identifies the calling routine using one or more of the resolver and a software call stack.

10. The activity recording system of claim 1 wherein the synchronization state of the software thread is determined by one or more of the software thread itself and the concurrent software environment.

11. The activity recording system of claim 4 wherein the exclusionary construct is one of a lock and a monitor.

12. The activity recording system of claim 5 wherein the shared resource is a software object.

13. A method for recording activity for a concurrent software environment executing software threads in a computer system, the method comprising the steps of:
recording an indication of a synchronization state of a software thread, the indication being associated with an identification of the software thread;
polling values of a program counter for a processor of the computer system at regular intervals; and
identifying and recording one or more synchronization states of the software thread based on the polled program counter value and the recorded indication of state.

14. A computer system comprising:
a processor;
a memory comprising instructions; and
a bus interconnecting the processor and the memory, wherein the processor executes the instructions to record an indication of a synchronization state of a software thread executing in the computer system, the indication being associated with an identification of the software thread, poll values of a program counter for the processor at regular intervals, and identify and record one or more synchronization states of the software thread based on the polled program counter value and the recorded indication of state.

15. A computer program storage element comprising computer program code to, when loaded into a computer system and executed thereon, cause the computer system to perform the steps of a method as claimed in claim 13.
